(19) United States
(12) Patent Application Publication
(10) Pub. No.: US 2018/0107619 A1
(43) Pub. Date: Apr. 19, 2018

(54) METHOD FOR SHARED DISTRIBUTED MEMORY MANAGEMENT IN MULTI-CORE SOLID STATE DRIVE

(71) Applicant: SAMSUNG ELECTRONICS CO., LTD., SUWON-SI (KR)

(72) Inventors: VIKRAM SINGH, BANGALORE (IN); CHANDRASHEKAR TANDAVAPURA JAGADISH, BANGALORE (IN); VAMSHI KRISHNA KOMURAVELLI, BANGALORE (IN); MANOJ THAPLIYAL, BANGALORE (IN)

(21) Appl. No.: 15/458,059

(22) Filed: Mar. 14, 2017

(30) Foreign Application Priority Data
Oct. 13, 2016 (IN) 201641034926

(51) Int. Cl. G06F 13/28; G06F 13/16; G06F 12/10

(52) U.S. Cl. CPC G06F 13/28; G06F 12/10; G06F 13/16

(57) ABSTRACT

Memory management in a multi-core solid state drive (SSD) includes distributing, by a memory access management system, multiple direct memory access (DMA) descriptors that describe a mechanism to access a local memory of each processor among multiple processors in the multi-core solid state drive. A direct memory access engine is configured with logical addresses corresponding to locations described by the direct memory access descriptors in the local memory of each processor. The logical addresses emulate a continuous memory.

### CROSS-REFERENCE TO RELATED APPLICATION

This U.S. non-provisional patent application claims priority under 35 U.S.C. § 119 to Indian Patent Application No. 201641034926, filed on Oct. 13, 2016 in the Indian Office of the Controller General of Patents, Designs & Trade Marks (CGPDTM), the contents of which are incorporated herein by reference in their entirety.

### BACKGROUND

### 1. Technical Field

The present disclosure relates to memory access in electronic devices. More particularly, the present disclosure relates to shared distributed memory management in multi-core Solid State Drives (SSDs) in digital devices.

### 2. Description of the Related Art

Solid State Drive (SSD) is a widely popular data storage mechanism used in digital devices. SSD supports different types of memory access mechanisms, a prominent one being Direct Memory Access (DMA). Multi-core SSD uses multiple processors (e.g., CPUs) or the core logic of multiple processors in a Solid State Drive.

As the name implies, DMA allows direct access to a memory unit, independently of a central processing unit; thus, providing comparatively faster memory access. However, in order to provide the faster memory access enabled by DMA, DMA may require the use of only fixed, permanent physical addresses, and existing DMA implementations tend to require use of a continuous memory (i.e., physically continuous memory units with corresponding continuous fixed, permanent physical addresses). This is fine in the case of a single-core SSD with a single processor for the entirety of the memory. However, in the case of a multi-core SSD, multiple processors may each be associated with dedicated local memories, such that the multi-core SSD memory overall cannot be characterized as continuous (i.e., with physically continuous memory units with corresponding continuous fixed, permanent physical addresses). Rather, in a multi-core SSD it may be that the dedicated local memories are physically separated, dedicated independently to one of multiple processors, be provided with discontinuous physical memory addresses, and so on.

Additionally, continuous memory may be accessed in a shared memory environment (i.e., with multiple devices/processors simultaneously provided with access to the memory). However, in such a shared memory environment, data requests are fetched one at a time in order to, for example, avoid conflicts between data requests. For performance-critical functions, this delay may prove fatal, and detracts from or nullifies the comparatively faster memory access that can otherwise be provided by direct memory access. This further affects performance of the entire system. Further, in the shared memory environment, where shared memory access is generally implemented by means of a bus like an Advanced eXtensible Interface (AXI), AMBA High Performance Bus (AHB), an Advanced Peripheral Bus (APB) and so on, requests from and to the core need to pass through the bus, and this adds to the delay, thus affecting performance of the system.

### SUMMARY

An object of the embodiments herein is to provide shared memory access in a multi-core SSD, i.e., that supports DMA, and without actually requiring continuous memory.

Another object of the embodiments herein is to maintain a mapping between physical address and logical address of data storage in the SSD.

Another object of the embodiments herein is to emulate continuous memory in DMA using logical address-physical address mapping, without actually requiring continuous memory.

In accordance with an aspect of the present disclosure, an embodiment herein provides a method for memory management in a multi-core Solid State Drive (SSD). Initially multiple Direct Memory Access (DMA) descriptors that describe a mechanism to access a local memory of each of multiple processors in the multi-core SSD are distributed by a memory access management system. A DMA descriptor may be, for example, a formulaic description of a relationship between a physical address and a logical address different than the physical address. Further, a DMA engine of the memory access management system is configured by the memory access management system with logical addresses corresponding to locations described by the DMA descriptors in the local memory of each processor of the processors. The logical addresses emulate a continuous memory without actually requiring a continuous memory.

In accordance with another aspect of the present disclosure, the memory access management system includes a hardware processor and a non-volatile memory. The non-volatile memory stores instructions that, when executed by the hardware processor, cause the memory access management system to distribute multiple Direct Memory Access (DMA) descriptors that describe a mechanism to access a local memory of each of multiple processors in a multi-core SSD. Further, a DMA engine of the memory access management system is configured with logical addresses corresponding to locations described by the DMA descriptors in the local memories. The logical addresses emulate a continuous memory without actually requiring a continuous memory.

### BRIEF DESCRIPTION OF THE DRAWINGS

The above and other aspects and features of the present disclosure will become more apparent by describing in detail exemplary embodiments thereof with reference to the attached drawings, in which:

FIG. 1 illustrates a block diagram of a memory access management system, as disclosed in the embodiments herein;

FIG. 2 is a flow diagram that depicts steps involved in the process of memory management by the memory access management system, as disclosed in the embodiments herein;

FIG. 3 illustrates an example of the memory mapping performed in the Direct Memory Access (DMA) engine of the memory access management system for accessing distributed DMA Descriptors that that describe mechanisms for accessing the data stored in memories closely associated with each processor core of the memory access management system, as disclosed in the embodiments herein; and

FIG. 4 illustrates application of the memory access management system to reduce memory-copy operations by logically mapping the address for the DMA Engine between two processors of the memory access management system.

### DETAILED DESCRIPTION OF THE EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

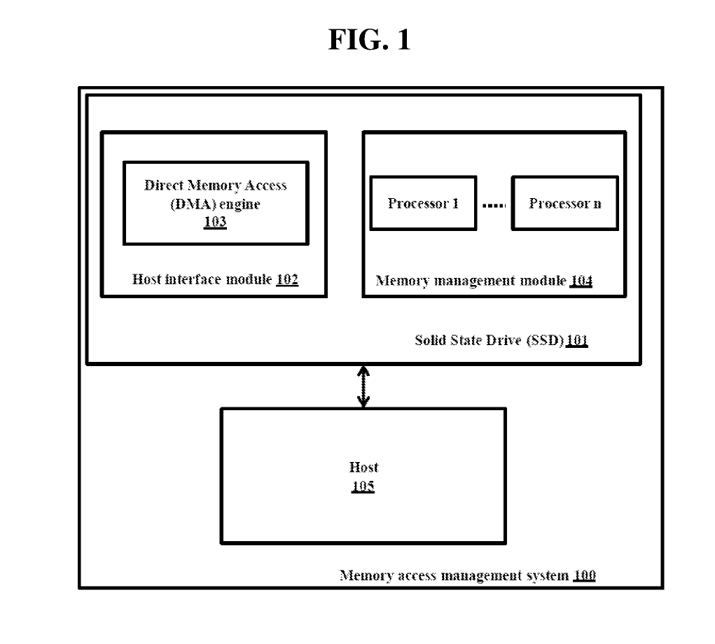

The embodiments herein disclose mechanisms for shared distributed memory access using a memory access management system. Referring now to the drawings, and more particularly to FIGS. 1 through 3, embodiments shown in the drawings include similar reference characters to denote corresponding features consistently throughout the figures.

FIG. 1 illustrates a block diagram of a memory access management system, as disclosed in the embodiments herein. The memory access management system 100 includes a multi-core Solid-State Drive (SSD) 101. The memory access management system 100 is configured to distribute DMA descriptors to local memories (not shown) of the multiple processors (i.e., processor 1 to processor n) shown therein in a memory management module. That is, in FIG. 1, the multi-core SSD 101 includes a memory management module 104, which in turn includes two or more processors, i.e., processor 1 to processor n. Each of the two or more processors may include or be associated with a dedicated memory, such that the overall memory of the multi-core SSD 101 is not continuous memory. That is, in FIG. 1, the local memories of processor 1 to processor n are memories local to, dedicated to, or otherwise corresponding specifically to only one processors in the SSD 101.

Additionally, in FIG. 1 the memory access management system 100 includes a Direct Memory Access (DMA) engine 103 in a host interface module 102. The SSD 101 can be configured to communicate with at least one host 105, using a suitable communication interface. The SSD 101 therefore includes the host interface module 102 and the memory management module 104. The memory management module 104 includes the multiple processors, i.e., processor 1 to processor n. In an embodiment, at least the critical data required for functioning of each processor is stored in the individual memory locally associated with (e.g., dedicated to) the processor.

The Direct Memory Access (DMA) engine 103 can be configured to facilitate memory access for one or more host(s) 105 connected to the SSD 101 in the memory access management system 100. The DMA engine 103 can be further configured to provide read and write access to the memory in the SSD 101, for the host(s) 105. In an embodiment, the DMA engine 103 maintains, in an associated storage space, a mapping database that can be used to store information pertaining to mapping between logical addresses and physical addresses of different memory locations associated with the processors. The mapping information may be stored permanently or temporarily, and may be used when the DMA engine 103 determines the physical address corresponding to each logical address. In an embodiment, the DMA engine 103 dynamically determines a physical address corresponding to a logical address, by processing the logical address extracted from a memory access request. In another embodiment, the mapping information including predetermined and correlated logical addresses and physical addresses is configured during initialization of the memory access management system 100.

The DMA engine 103 can be configured to receive memory access request(s) from at least one host 105. The memory access request can be related to at least one of a read and write operation. The DMA engine 103 can be further configured to extract, by processing the received memory access request, a logical address of the memory that needs to be accessed in response to the request. The DMA engine 103 further processes the extracted logical address to dynamically determine a physical address of the memory location(s) to which access is requested. In an embodiment, the DMA engine 103 determines the physical address as:

Physical address=pool address+(Descriptor size*Descriptor offset) (1)

### Where,

Pool address->is the logical address extracted

Descriptor size->refers to a size of a chunk of memory to be accessed

Descriptor offset->is a pre-configured value that refers to an offset from a base of the logical address

The physical address can be determined from a logical address in a variety of ways, so the formula (1) above is only exemplary. For instance, an offset may be a value that only needs to be added or subtracted from a logical address.

In an embodiment, the physical address is determined/calculated, each time a memory access request is received, by the DMA engine 103. Additionally, the DMA engine 103 further maps the extracted logical address to the determined physical address. In another embodiment, the DMA engine 103 is configured to store information pertaining to a physical address corresponding to a logical address in a mapping database. The information pertaining to the physical address can be used as reference data at any point of time for the DMA engine 103 to determine the physical address corresponding to a logical address.

Based on the physical address, the DMA engine 103 accesses the memory location and performs the read and/or write operation. The mapping allows emulation of a continuous memory (which is required by the DMA engine 103), while the data is retained in separate, discontinuous memories which are each local to one of the processors. The logical addresses of memory locations are continuous and this makes the DMA engine 103 believe that the data is stored in a continuous memory. Storing the data in memory locations local to each processor allows faster access to the data; thus, reducing or eliminating latency as an enhancement to the faster access provided by DMA itself.

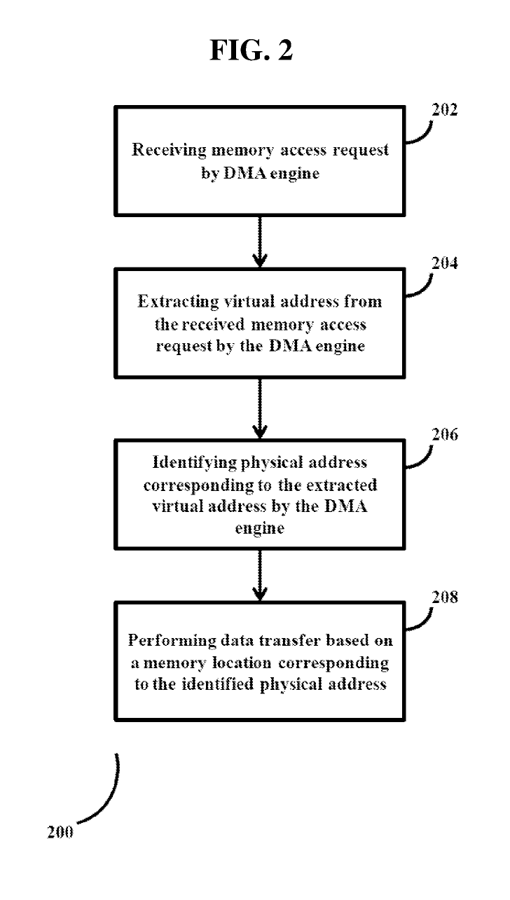

FIG. 2 is a flow diagram that depicts steps involved in the process of memory management by the memory access management system, as disclosed in the embodiments herein. The DMA engine 103 receives (202) a memory access request from at least one host 105, wherein the memory access request corresponds to at least one of a read and write operation. While the read operation allows the host to read data stored in the memory of the SSD 101, the write operation allows the host to write data to the memory which in turn is stored in the memory of the SSD 101.

The DMA engine 103 processes the received memory access request and extracts (204) a logical (virtual) address of the memory location to which access is requested. In an embodiment, the logical (virtual) address is a part of the memory access request. The DMA engine 103, by processing the extracted logical address, identifies (206) a physical address of the memory location to which access is requested. The DMA engine 103 then performs (208) data transfer as per the request received from the host 105, from and/or to the memory location which is located based on the identified physical address. The data transfer performed can be associated with a read and/or write operation. The various actions in method 200 may be performed in the order presented, in a different order or simultaneously. Further, in some embodiments, some actions listed in FIG. 2 may be omitted.

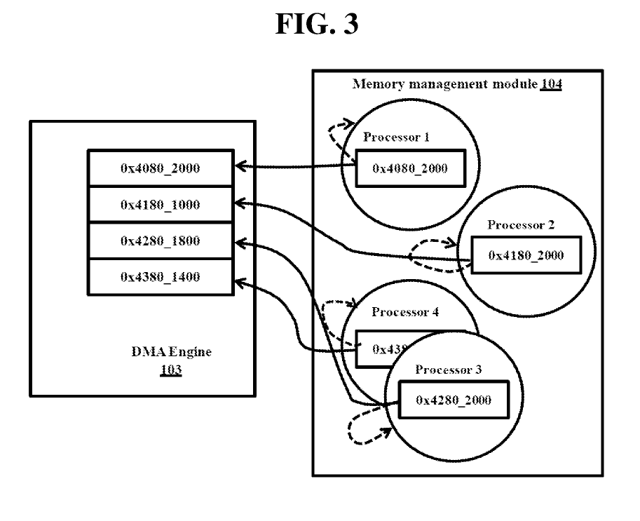

FIG. 3 illustrates an example of the memory mapping done in the Direct Memory Access (DMA) engine 103 of the memory access management system 100. The memory mapping is performed for accessing distributed DMA Descriptors that describe mechanisms to access the data stored in memories closely associated with each processor core of the memory access management system 100, as disclosed in the embodiments herein. Here, the data is stored in memories which are closely associated with the processors and which allow faster data access for the processors. For example, the memory can be a Tightly Coupled Memory (TCM) associated with each processor. The physical addresses of the memories are 0x4080_2000, 0x4180_2000, 0x4280_2000, and 0x4380_2000 respectively. Values of the physical addresses given here are only for example purpose and can vary in different implementation scenarios. According to the mapping database in the DMA engine 103, the addresses of the memory locations are 0x4080_2000, 0x4180_1000, 0x4280_1800, and 0x4380_1400 respectively. The addresses stored in the DMA engine 103 are logical addresses which emulate a continuous memory, while the data is actually not stored in a continuous memory. Instead, the data may be stored in discontinuous memory, such as memories that are physically separated, memories dedicated to different processors, and/or memories that do not have continuous physical addresses. The physical addresses of the memory locations are mapped to corresponding logical addresses, and upon receiving a memory access request, the memory location is identified based on the data in the mapping database. Storing data in memory locations local to the processors helps in reducing latency in terms of time required for a processor to access data from the memory, as compared to time required to access data from a continuous shared memory. In this process, DMA engine 103 interfaces for memory access automatically point to next memory locations after memory access operation on the previous locations, facilitating continuous access to the memory. That is, for memory access that spans across multiple physically discontinuous local memories of the multiple processor in the multi-core SSD 101, the DMA engine interface will automatically point to the next discontinuous memory location that follows access to the previous discontinuous memory location.

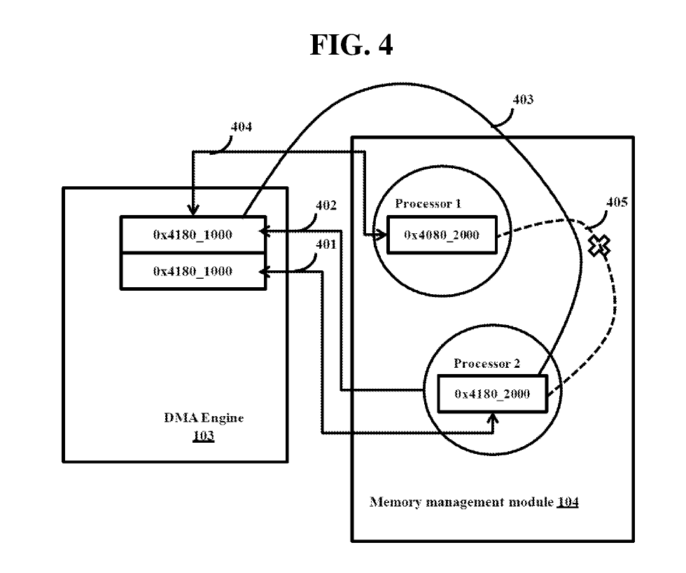

FIG. 4 illustrates application of the memory access management system to reduce memory-copy operation by logically mapping the address for the DMA Engine 103 between two processors of the memory access management system 100. In a scenario, during DMA operations in the memory access management system 100, the DMA Engine 103 must work using two memories residing locally to processors1 and processor 2 in the memory management module 104. In a scenario during DMA memory operations, there is a sequence of steps for accessing the memory (for example, TCM) associated with the processor. In the sequence, Processor 1 memory can be processed only after Processor 2 memory is processed, but Processor1 memory must have the same contents as Processor 2 memory. The method described herein enables eliminating a COPY (405) operation utilized currently that copies contents of memory of Processor 2 to memory of Processor 1. The method enables DMA Engine Interfaces for memory addresses to be remapped (402) after a first operation involving Processor 2 (401). After remapping (403), the DMA Engine (103) can point (403) to Processor 2 memory and the additional copy operation (405) is not needed. Thus, when the data stored at the memory is to be accessed for, the DMA Engine (103) can point (403) to the data in the local memory of Processor 2. The local memory of Processor 1 that would otherwise be used for the copied data is then free for, e.g., writing other data at S404.

The embodiments disclosed herein can be implemented through at least one software program running on at least one hardware device and performing network management functions to control the network elements. The network elements shown in FIG. 1 include blocks which can be at least one of a hardware device, or a combination of hardware device and software module.

The embodiments disclosed herein specify a memory access mechanism in DMA systems. The mechanism allows emulation of continuous memory in DMA, providing a system thereof. Therefore, it is understood that the scope of protection is extended to such a system and by extension, to a computer readable means having a message therein, the computer readable means containing a program code for implementation of one or more steps of the method, when the program runs on a server or mobile device or any suitable programmable device. The method is implemented in a preferred embodiment using the system together with a software program written in, for ex. Very high speed integrated circuit Hardware Description Language (VHDL), another programming language, or implemented by one or more VHDL or several software modules being executed on at least one hardware device. The hardware device can be any kind of device which can be programmed including, for ex. any kind of a computer like a server or a personal computer, or the like, or any combination thereof, for ex. one processor and two FPGAs. The device may also include means which could be for ex. hardware means like an ASIC or a combination of hardware and software means, an ASIC and an FPGA, or at least one microprocessor and at least one memory with software modules located therein. Thus, the means are at least one hardware means or at least one hardware-cum-software means. The method embodiments described herein could be implemented in pure hardware or partly in hardware and partly in software. Alternatively, the embodiment may be implemented on different hardware devices, for ex. using multiple CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

What is claimed is:

1. A method for memory management in a multi-core solid state drive (SSD), comprising:
distributing, by a memory access management system, a plurality of direct memory access (DMA) descriptors that describe a mechanism to access a local memory of each processor of a plurality of processors in the multi-core solid state drive; and
configuring, by the memory access management system, a direct memory access engine of the memory access management system with logical addresses corresponding to locations described by the plurality of direct memory access descriptors in the local memory of each processor of the plurality of processors,
wherein the logical addresses emulate a continuous memory.

2. The method as claimed in claim 1, further comprising:
performing a memory access that includes:
receiving, by the direct memory access engine from a processor among the plurality of processors, a memory access request comprising a descriptor offset;
extracting, by the direct memory access engine, a logical address corresponding to at least one memory location indicated in the memory access request, based on the descriptor offset;
determining, by the direct memory access engine, a physical address corresponding to the extracted logical address; and
providing, by the direct memory access engine, access to a memory location corresponding to the determined physical address, in response to the memory access request.

3. The method as claimed in claim 2, wherein the determined physical address is determined dynamically by the direct memory access engine.

4. The method as claimed in claim 2, wherein the extracted logical address is mapped to the determined physical address by the direct memory access engine.

5. A memory access management system, comprising:
a hardware processor;
a non-volatile memory that stores instructions that, when executed by the hardware processor, cause the memory access management system to perform a process comprising:
distributing a plurality of direct memory access (DMA) descriptors that describe a mechanism to access a local memory of each processor of a plurality of processors in a multi-core solid state (SSD); and
configuring a direct memory access engine of the memory access management system with logical addresses corresponding to locations described by the plurality of direct memory access descriptors in the local memory of each processor of the plurality of processors,
wherein the logical addresses emulate a continuous memory.

6. The memory access management system as claimed in claim 5, wherein the memory access management system is configured to perform memory access by a process comprising:
receiving, by the direct memory access engine, a memory access request from a processor among the plurality of processors;
extracting, by the direct memory access engine, a logical address corresponding to at least one memory location indicated in the memory access request;
identifying, by the direct memory access engine, a physical address corresponding to the extracted logical address; and
providing, by the direct memory access engine, access to a memory location corresponding to the identified physical address, in response to the memory access request.

7. The memory access management system as claimed in claim 6, wherein the direct memory access engine is further configured to dynamically determine the identified physical address.

8. The memory access management system as claimed in claim 6, wherein the direct memory access engine is further configured to map the extracted logical address to the identified physical address.

9. A method for memory management in a multi-core solid state drive (SSD) that includes a plurality of separate discontinuous memories each dedicated to a separate processor of a plurality of processors in the multi-core solid state drive, the method comprising:
setting a plurality of logical addresses for the plurality of separate discontinuous memories in the multi-core solid state drive so that the plurality of separate discontinuous memories in the multi-core solid state drive have continuous logical addresses;
configuring a direct memory access engine of the multi-core solid state drive to translate a direct memory access (DMA) request that includes a logical address among the continuous logical addresses into a physical address in one of the separate discontinuous memories.

10. The method of claim 9, further comprising:
distributing a direct memory access descriptor that describes a mechanism to access the physical address in the one of the separate discontinuous memories using the logical address among the continuous logical addresses.

11. The method of claim 10,
wherein the direct memory access descriptor further includes an offset value that describes an offset from the logical address among the continuous logical addresses.

12. The method of claim 9,
wherein the direct memory access engine coordinates the continuous logical addresses for all of the plurality of processors in the multi-core solid state drive.

13. The method of claim 10, further comprising:
receiving, by the direct memory access engine, a memory access request for data starting at the physical addresses in the one of the separate discontinuous memories.

14. The method of claim 13, further comprising:
extracting, for the memory access request received by the direct memory access engine, the logical address among the continuous logical addresses.

15. The method of claim 14, further comprising:
identifying, for the memory access request received by the direct memory access engine, the physical address in the one of the separate discontinuous memories using the extracted logical address.

16. The method of claim 15, further comprising:
performing, for each memory access request received by the direct memory access engine, data transfer based on a memory location corresponding to the identified physical address.

17. The method of claim 16,
wherein the continuous logical addresses emulate a continuous memory.

18. The method of claim 15,
wherein the identified physical address is identified dynamically by the direct memory access engine.

19. The method of claim 15,
wherein the extracted logical address is mapped to the physical address by the direct memory access engine.
